(19) United States
(12) Patent Application Publication
(10) Pub. No.: US 2005/0071756 A1
(43) Pub. Date: Mar. 31, 2005

(54) XML to numeric conversion method, system, article of manufacture, and computer program product

(75) Inventors: Teodoro Cipresso, San Jose, CA (US); Andrzej McColl Krasun, Broughton (GB); Gary Isaak Mazo, San Jose, CA (US); William Nicholas John Tindall, San Martin, CA (US)

Correspondence Address: INTERNATIONAL BUSINESS MACHINES CORP;IP LAW, 555 BAILEY AVENUE , J46/G4, SAN JOSE, CA, 95141, US

(73) Assignee: International Business Machines Corporation, Armonk, NY (US)

(21) Appl. No.: 10/669,770

(22) Filed: Sep. 23, 2003

(51) Int. Cl. G06F 17/21

(52) U.S. Cl. 715/513

(57) ABSTRACT

A text representation of a number is converted into a numeric representation of the number by converting the text representation of the number into a description of the number's format; mapping the description of the number's format to a sequence of conversion code; and converting the text representation of the number into the numeric representation of the number by use of the sequence of conversion code. Preferably, the description of the number's format is a picture string; the text representation of the number is converted into a description of the number's format by a translation instruction using a translate table; and the sequence of conversion code for converting the text representation of the number into the numeric representation of the number comprises an assignment statement.

A portion of the Disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates in general to computer programs, and more particularly to converting a textual representation of a number into a numeric representation of the number.

2. Description of the Related Art

Tagged message formats such as Extended Markup Language (XML) are rapidly replacing fixed-format message formats that typify Electronic Data Interchange (EDI) because the tagged message formats are so much more flexible. However, the fixed-format messages are much more efficient from storage and processing perspectives as they may be typically be processed hundreds, or even thousands of times, more quickly than corresponding tagged format messages. For example, information describing a customer account may be represented by the following EDI fixed-format message (where the “b” characters represent spaces):
0317789362JohnbbbbbbbbbbQCitizenbbbbbbbb0003475.990000069.23

The same information may be represented by the following XML tagged format message:

<?xml version=″1.0″?>
<Account>
<Number>031-778936-2</Number>
<Name>
<First>John</First>
<MI>Q</MI>
<Last>Citizen<>
</Name>
<OldBalance>3475.75</OldBalance>
<NewBalance>69.23</NewBalance>
</Account>

Although the XML tagged format is self-evidently clearer and more flexible, processing it is far less efficient than processing fixed-format data. There are various reasons why processing tagged messages is slower. Two of the main reasons are:

1. The receiving program has to analyze the message, character by character, to distinguish markup (the tags) from message content. This process is called “parsing,” and is computationally very expensive.

2. The message content itself (between the markup tags) typically does not have a fixed-format, and this format must be determined before the content can be processed. Discovering the format by using conventional techniques is also computationally expensive.

In a fixed-format message, a numeric quantity is always the same size, and has the same number of integer and decimal places and so on. In a tagged message format, the representation of the same numeric quantity can vary very widely. For example, with a fixed format of six integer places, a decimal point and two decimal places, the number 20 would always be represented exactly as: 000020.00. In the unconstrained formats that are typical for tagged format messages, the number 20 may be represented in a variety of ways: 20, 20., 20.00, 000020.00, et cetera. Such variability is one of the benefits of using tagged format messages as the sender and receiver of a message do not need to have identical definitions, and can evolve separately. However, this flexibility may come at a penalty in performance if the receiver of the message uses a conventional method of acquiring the incoming data values. For instance, a generalized numeric conversion function may accept any of the illustrated formats, converting them to a standardized representation that could then be assigned to the appropriate program variable. Unfortunately, this may require over a thousand machine instructions.

Thus, there is a clearly felt need for an improved conversion of a textual representation of a number into a numeric representation of the number.

### SUMMARY OF THE INVENTION

Preferred embodiments of the present invention comprise a method, system, article of manufacture, and computer program product for converting a textual representation of a number into a numeric representation of the number.

In accordance with a preferred embodiment of the present invention, a text representation of a number is converted into a numeric representation of the number by converting the text representation of the number into a description of the number's format; mapping the description of the number's format to a sequence of conversion code; and converting the text representation of the number into the numeric representation of the number by use of the sequence of conversion code.

In accordance with an aspect of a preferred embodiment of the present invention, the description of the number's format is a picture string.

In accordance with another aspect of a preferred embodiment of the present invention, the text representation of the number is converted into a description of the number's format by a translation instruction using a translate table.

In accordance with another aspect of a preferred embodiment of the present invention, the sequence of conversion code for converting the text representation of the number into the numeric representation of the number comprises an assignment statement.

In accordance with another aspect of a preferred embodiment of the present invention, the mapping of the description of the number's format to a sequence of conversion code comprises mapping the description of the number's format to an index which is used to transfer control to the sequence of conversion code corresponding to the description of the number's format.

In accordance with another aspect of a preferred embodiment of the present invention, if the text representation of the number does not convert into the description of the number's format, then the subsequent mapping and converting steps are not executed.

A preferred embodiment of the present invention has the advantage of providing improved conversion of a textual representation of a number into a numeric representation of the number.

A preferred embodiment of the present invention has the advantage of reducing execution time for conversion of a textual representation of a number into a numeric representation of the number

A preferred embodiment of the present invention has the advantage of reducing memory for conversion of a textual representation of a number into a numeric representation of the number.

A preferred embodiment of the present invention has the advantage of reducing an amount of program code for conversion of a textual representation of a number into a numeric representation of the number.

### BRIEF DESCRIPTION OF THE DRAWINGS

For a more complete understanding of the present invention and the advantages thereof, reference is now made to the Description of the Preferred Embodiment in conjunction with the attached Drawings, in which:

FIG. 1 is a block diagram of a preferred embodiment of the present invention;

FIG. 2 illustrates a sample use of preferred embodiment of the present invention;

FIG. 3 is a flowchart of method steps preferred in carrying out a preferred embodiment of the present invention; and

FIG. 4 is a block diagram of a computer system used in performing a method of a preferred embodiment of the present invention, forming part of an apparatus of a preferred embodiment of the present invention, storing a data structure of a preferred embodiment of the present invention, and which may use an article of manufacture comprising a computer-readable storage medium having a computer program embodied in said medium which may cause the computer system to practice a preferred embodiment of the present invention.

### DESCRIPTION OF THE PREFERRED EMBODIMENT

An embodiment of the invention is now described with reference to the figures where like reference numbers indicate identical or functionally similar elements. Also in the figures, the left most digit of each reference number corresponds to the figure in which the reference number is first used. While specific configurations and arrangements are discussed, it should be understood that this is done for illustrative purposes only. A person skilled in the relevant art will recognize that other configurations and arrangements can be used without departing from the spirit and scope of the invention. It will be apparent to a person skilled in the relevant art that this invention can also be employed in a variety of other devices and applications.

The preferred embodiment of the present invention directs control for a given input value to a set of previously compiled program statements that process the exact format of each particular instance of the input value. This is accomplished in three major steps. First, each digit in the textual representation input value is converted to the digit 9, which can be accomplished with a single machine instruction on many models of IBM mainframe computers. This converted value is a valid descriptor, the picture string. For example, if the textual representation input value is 0000020.00, then its descriptor or picture string is 9999999.99 and its length is 10.

An efficient way of acquiring a numeric value from a message and assigning it to a program variable is to use a compiled language assignment statement, such as a COBOL MOVE statement. However, an individual MOVE statement is specific to and only works correctly for a particular number format. Thus, if a set of suitable MOVE statements is provided, each one for a particular format, and if the program can determine the particular format, then the program can transfer control to the appropriate MOVE statement. The problem is discovering the format of the number and transferring control in a manner that the advantages of the high performance compiled MOVE statement are not lost due to the cost of determining the format of the number. Ideally, the format of the number would be instantaneously determined at no cost to provide a description of the format of the number in a form that could be used to direct control to the appropriate compiled MOVE statement. The invention significantly reduces the cost associated with such a determination.

In the preferred embodiment of the present invention, a COBOL MOVE statement is used to convert the textual representation of a number into the numeric representation of the number. The COBOL language can describe the format of a data item in terms of a “picture string.” In the picture string for a numeric quantity, each decimal digit position is represented by the character ‘9’, the decimal point by the character ‘.’ and so on. For example, the picture string description for the number “12345.67” is “99999.99”. The data descriptions and the MOVE statement that can correctly assign this number to an operational data item are as follows:
01 NUMBER-IN-MESSAGE USAGE DISPLAY PICTURE 99999.99.
01 OPERATIONAL-DATA-ITEM USAGE COMPUTATIONAL PICTURE 9999999V99.
. . .
MOVE NUMBER-IN-MESSAGE TO OPERATIONAL-DATA-ITEM

However, this MOVE statement only correctly converts the textual representation of the number into the numeric representation of the number if the textual representation of the number has exactly five integer digits, followed by one decimal point, followed by two decimal digits. The preferred embodiment of the present invention uses a novel method to transform the textual representation of the number into a description of its format in terms of its “picture” with a single machine instruction. This description is converted into a number which becomes an argument to a computed GO TO statement that passes control to a proper MOVE statement for converting the textual representation of the number into the numeric representation of the number.

The preferred embodiment of the present invention directs control for a given input value to a set of previously compiled program statements that process the exact format of each particular instance of the input value. This is accomplished in three major steps. First, each digit in the textual representation input value is converted to the digit 9, which can be accomplished with a single machine instruction on many models of IBM mainframe computers. This converted value is a valid descriptor, the picture string. For example, if the textual representation input value is 0000020.00, then its descriptor or picture string is 9999999.99 and its length is 10.

Although the COBOL language statement that the preferred embodiment uses to implement the conversion appears complicated:
INSPECT PL-1 REPLACING ALL
‘0’ BY ‘9’‘1’ BY ‘9’‘2’ BY ‘9’‘3’ BY ‘9’‘4’ BY ‘9’
‘5’ BY ‘9’‘6’ BY ‘9’‘7’ BY ‘9’‘8’ BY ‘9″’ BY ‘?’
   the code generated by the COBOL compiler for this statement consists of only the single machine instruction “translate”, operation code “TR”:
TR PL-1, TRANSLATE-TABLE
   The translate table embodies the above set of character replacements wherein ‘0’, ‘1’, ‘2’, ‘3’, ‘4’, ‘5’, ‘6’, ‘7’, and ‘8’ are replaced by ‘9’, wherein a space character is replaced by ‘?’, and wherein other characters remain unchanged.

In the second major step, the picture string produced by the first step is mapped to a number using techniques well known in the art such as a binary search or hashing. This number is then used in a computed GOTO statement to transfer control to the assignment statement that corresponds exactly with the picture string for the input value. Some examples of these assignment statements are:

. . .
M7-D1-W5D2D.

MOVE S-D1 TO T-W5D2D
GO TO CONTENT-TRANSFORMED-EXIT

. . . .
M7-W4D2-W5D2D.

MOVE S-W4D2 TO T-W5D2D
GO TO CONTENT-TRANSFORMED-EXIT

. . .

The naming of the labels, such as “M7-W4D2-W5D2D”, gives indicates the semantics of the assignments: “M7” implies that the answer will occupy 7 digit positions; “W4D2” means that the source has 4 digits before the decimal point and 2 digits after it; “W5D2D” mean that the target has 5 digits before the decimal point and 2 digits after it.

If the picture string cannot be mapped to a number, then the textual representation of the input value does not have one of the expected formats. In this case in the third major step, control falls through to the standard library conversion routine, which can convert valid but uncommon formats. Using this standard conversion has the additional benefit that, if invalid input is received, it will not be erroneously placed automatically into the output. For example, an input value of “34AB449.12” will translate to an invalid picture string “99AB999.99” which does not match any valid picture string such as “9999999.99”.

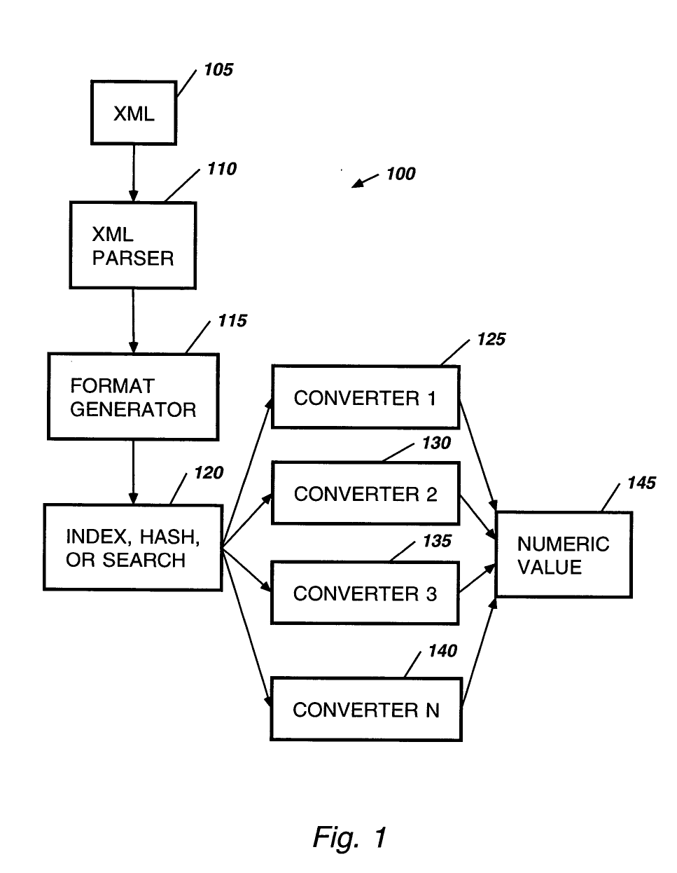

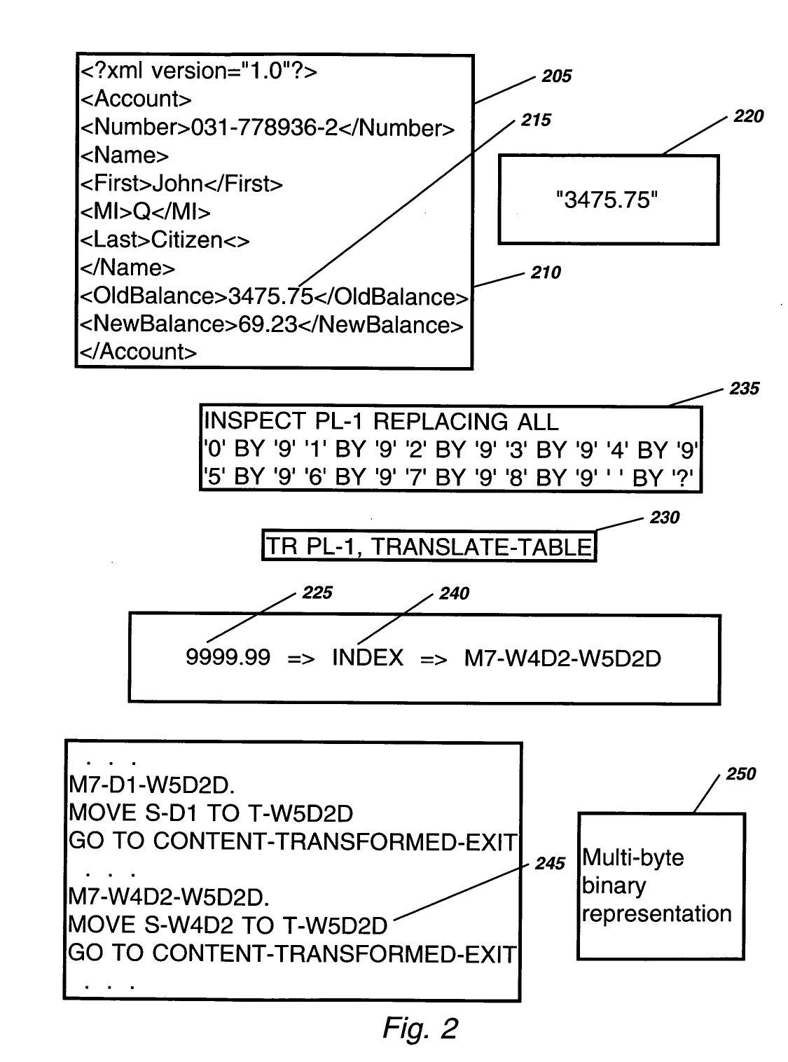

Referring now to FIG. 1 and FIG. 2, data such as an XML document 105 may contain a textual representation of a number which requires conversion into a numeric representation of the number before assignment to a program variable. The XML document 105 contains XML statements 205, and in particular, an XML statement 210 containing a textual representation 215 of a number which requires conversion into a numeric representation of the number before assignment to a program variable. The XML document 105 is parsed by a conventional XML parser 110 which upon parsing and identifying the textual representation 215 extracts the textual representation 220 and provides it to a format generator 115. The format generator transforms the textual representation 220 of the number into a description 225 of its format in terms of its “picture string”. This transformation is preferably performed by a single TRANSLATE machine instruction 230 which may be produced from a compilation of a COBOL INSPECT statement 235. This description or picture string is converted into a number (120 and 240) which becomes an argument to a computed GO TO statement that passes control to a proper converter from a group of converters comprising converter 1 125, converter 2 130, converter 3 135, . . . or converter N 140 containing the proper MOVE statement 245 for converting the textual representation of the number into the numeric representation (145 and 250) of the number.

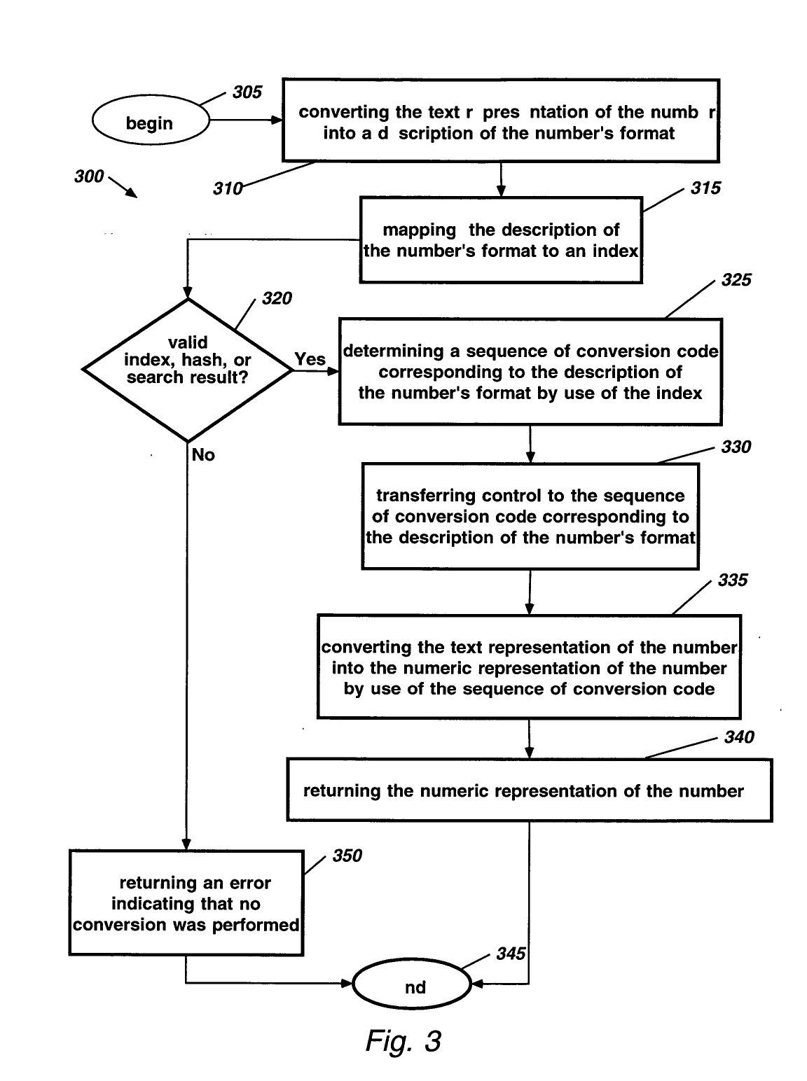

Referring now to FIG. 3, the flowchart 300 illustrates the operations preferred in carrying out the preferred embodiment of the present invention. In the flowcharts, the graphical conventions of a diamond for a test or decision and a rectangle for a process or function are used. These conventions are well understood by those skilled in the art, and the flowcharts are sufficient to enable one of ordinary skill to write code in any suitable computer programming language.

After the start 305 of the process 300, process block 310 converts the text representation of the number into a description of the number's format, and process block 315 maps the description of the number's format to an index. Thereafter, decision block 320 determines if a valid index, hash, or search result was produced by the mapping of the description of the number's format to an index. If a valid index, hash, or search result was produced by the mapping of the description of the number's format to an index, then process block 325 determines a sequence of conversion code corresponding to the description of the number's format by use of the index. Process block 330 transfers control to the sequence of conversion code corresponding to the description of the number's format. Process block 335 converts the text representation of the number into the numeric representation of the number by use of the sequence of conversion code. Process block 340 returns the numeric representation of the number. The process ends at process block 345.

Returning now to decision block 320, if a valid index, hash, or search result was not produced by the mapping of the description of the number's format to an index, then control passes to process block 350 which returns an error indicating that no conversion was performed, and the process ends at process block 345.

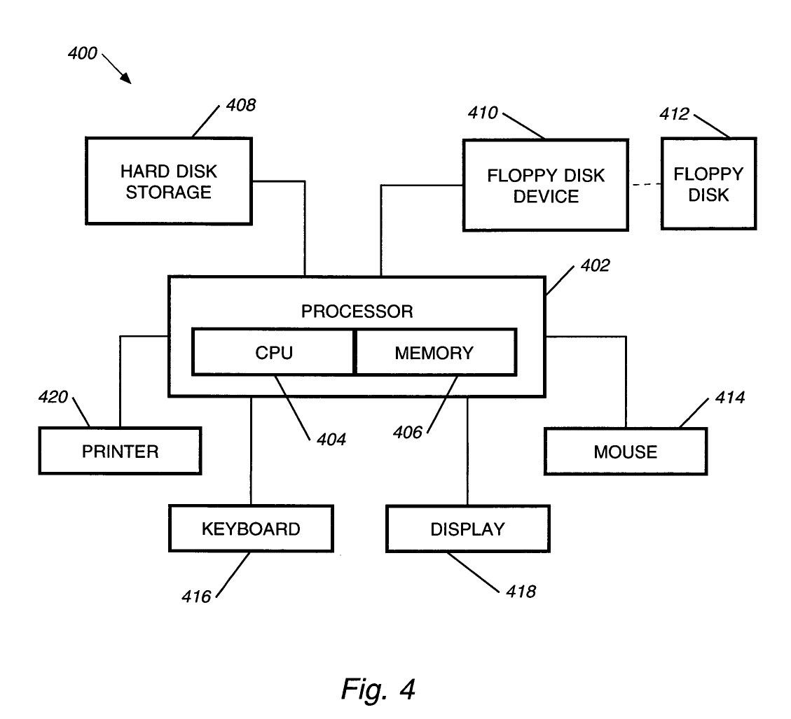

With reference now to the figures, and in particular with reference to FIG. 4, there is depicted a pictorial representation of a computer system 400 which may be utilized to implement a method, system, article of manufacture, data structure, and computer program product of preferred embodiments of the present invention. The block diagram of FIG. 4 illustrates a computer system 400 used in performing the method of the present invention, forming part of the apparatus of the present invention, and which may use the article of manufacture comprising a computer-readable storage medium having a computer program embodied in said medium which may cause the computer system to practice the present invention. The computer system 400 includes a processor 402, which includes a central processing unit (CPU) 404, and a memory 406. Additional memory, in the form of a hard disk file storage 408 and a computer-readable storage device 410, is connected to the processor 402. Computer-readable storage device 410 receives a computer-readable storage medium 412 having a computer program embodied in said medium which may cause the computer system to implement the present invention in the computer system 400. The computer system 400 includes user interface hardware, including a mouse 414 and a keyboard 416 for allowing user input to the processor 402 and a display 418 for presenting visual data to the user. The computer system may also include a printer 420.

Using the foregoing specification, the invention may be implemented using standard programming and/or engineering techniques using computer programming software, firmware, hardware or any combination or sub-combination thereof. Any such resulting program(s), having computer readable program code means, may be embodied within one or more computer usable media such as fixed (hard) drives, disk, diskettes, optical disks, magnetic tape, semiconductor memories such as Read-Only Memory (ROM), Programmable Read-Only Memory (PROM), etc., or any memory or transmitting device, thereby making a computer program product, i.e., an article of manufacture, according to the invention. The article of manufacture containing the computer programming code may be made and/or used by executing the code directly or indirectly from one medium, by copying the code from one medium to another medium, or by transmitting the code over a network. An apparatus for making, using, or selling the invention may be one or more processing systems including, but not limited to, central processing unit (CPU), memory, storage devices, communication links, communication devices, servers, input/output (I/O) devices, or any sub-components or individual parts of one or more processing systems, including software, firmware, hardware or any combination or sub-combination thereof, which embody the invention as set forth in the claims. User input may be received from the keyboard, mouse, pen, voice, touch screen, or any other means by which a human can input data to a computer, including through other programs such as application programs, databases, data sets, or files.

One skilled in the art of computer science will easily be able to combine the software created as described with appropriate general purpose or special purpose computer hardware to create a computer system and/or computer sub-components embodying the invention and to create a computer system and/or computer sub-components for carrying out the method of the invention. Although the present invention has been particularly shown and described with reference to a preferred embodiment, it should be apparent that modifications and adaptations to that embodiment may occur to one skilled in the art without departing from the spirit or scope of the present invention as set forth in the following claims.

1. An article of manufacture for use in a computer system for converting a text representation of a number into a numeric representation of the number, said article of manufacture comprising a computer-useable storage medium having a computer program embodied in said medium which causes the computer system to execute the method steps comprising:
converting the text representation of the number into a description of the number's format;
mapping the description of the number's format to a sequence of conversion code; and
converting the text representation of the number into the numeric representation of the number by use of the sequence of conversion code.

2. The article of manufacture of claim 1 wherein the description of the number's format is a picture string.

3. The article of manufacture of claim 1 wherein the text representation of the number is converted into a description of the number's format by a translation instruction using a translate table.

4. The article of manufacture of claim 1 wherein the sequence of conversion code for converting the text representation of the number into the numeric representation of the number comprises an assignment statement.

5. The article of manufacture of claim 1 wherein the mapping of the description of the number's format to a sequence of conversion code comprises mapping the description of the number's format to an index which is used to transfer control to the sequence of conversion code corresponding to the description of the number's format.

6. The article of manufacture of claim 1 wherein if the text representation of the number does not convert into the description of the number's format, then not executing the subsequent mapping and converting steps.

7. A method for use in a computer system for converting a text representation of a number into a numeric representation of the number, said method comprising:
converting the text representation of the number into a description of the number's format;
mapping the description of the number's format to a sequence of conversion code; and
converting the text representation of the number into the numeric representation of the number by use of the sequence of conversion code.

8. The method of claim 7 wherein the description of the number's format is a picture string.

9. The method of claim 7 wherein the text representation of the number is converted into a description of the number's format by a translation instruction using a translate table.

10. The method of claim 7 wherein the sequence of conversion code for converting the text representation of the number into the numeric representation of the number comprises an assignment statement.

11. The method of claim 7 wherein the mapping of the description of the number's format to a sequence of conversion code comprises mapping the description of the number's format to an index which is used to transfer control to the sequence of conversion code corresponding to the description of the number's format.

12. The method of claim 7 wherein if the text representation of the number does not convert into the description of the number's format, then not executing the subsequent mapping and converting steps.

13. A computer system for converting a text representation of a number into a numeric representation of the number, said computer system comprising:
a converter for converting the text representation of the number into a description of the number's format;
a translator for mapping the description of the number's format to a sequence of conversion code; and
a converter for converting the text representation of the number into the numeric representation of the number by use of the sequence of conversion code.

14. The computer system of claim 13 wherein the description of the number's format is a picture string.

15. The computer system of claim 13 wherein the text representation of the number is converted into a description of the number's format by a translation instruction using a translate table.

16. The computer system of claim 13 wherein the sequence of conversion code for converting the text representation of the number into the numeric representation of the number comprises an assignment statement.

17. The computer system of claim 13 wherein the mapping of the description of the number's format to a sequence of conversion code comprises mapping the description of the number's format to an index which is used to transfer control to the sequence of conversion code corresponding to the description of the number's format.

18. The computer system of claim 13 wherein if the text representation of the number does not convert into the description of the number's format, then not executing the subsequent mapping and converting steps.
